(19) United States
(12) Patent Application Publication
(10) Pub. No.: US 2017/0313000 A1
(43) Pub. Date: Nov. 2, 2017

(54) METHOD FOR PRODUCING A STRUCTURAL COMPONENT FOR A MOTOR VEHICLE

(71) Applicant: Ford Global Technologies, LLC, Dearborn, MI (US)

(72) Inventors: Igor Licko, Piestany (SK); Raphael Koch, Odenthal (DE); Selahattin Türel Memili, Duisburg (DE)

(73) Assignee: Ford Global Technologies, LLC, Dearborn, MI (US)

(21) Appl. No.: 15/582,782

(22) Filed: May 1, 2017

(30) Foreign Application Priority Data
Apr. 29, 2016 (DE) 102016207354.0

(51) Int. Cl. B29C 70/78; B29C 65/00; B29C 65/48; B29K 101/10; B29K 105/08; B29K 705/02; B29L 31/30

(52) U.S. Cl. CPC B29C 70/78; B29C 66/721; B29C 66/7422; B29C 65/48; B29K 2105/0872; B29K 2705/02; B29L 2031/3005; B29K 2101/10

(57) ABSTRACT

The present disclosure relates to a method for producing a structural component for a motor vehicle, in particular a motor vehicle body component, which has a main body made of a metal material. The main body is provided at least partially with a reinforcing element made of a fiber-composite plastic. The method includes the steps of providing the main body, providing the reinforcing element, joining the main body and the reinforcing element together, and simultaneously heating the main body and the reinforcing element to a temperature and for a period of time which are chosen to be sufficiently high in order to harden both the metal material of the main body and also the fiber-composite plastic of the reinforcing element.

### CROSS-REFERENCE TO RELATED APPLICATIONS

This application claims priority to and the benefit of German Application No. 102016207354.0, filed on Apr. 29, 2016. The disclosures of the above applications are incorporated herein by reference.

### FIELD

The present disclosure relates to a method for producing a structural component for a motor vehicle, in particular a motor vehicle body component such as for example supports or pillars.

### BACKGROUND

The statements in this section merely provide background information related to the present disclosure and may not constitute prior art.

On the one hand, motor vehicle bodies should provide a high torsional rigidity and stability for the motor vehicle structure. On the other hand, the lowest possible weight is desired, in order, for example, to be able to lower the fuel consumption of the vehicle. For some time, structural components which are formed as composite components made of fiber-reinforced plastic (FRP) and metal have therefore become the center of interest. Particularly in vehicle construction, the high mechanical properties in combination with the low weight often result in superiority of such FRP-metal composite components over conventional aluminum and steel components.

Structural components formed as FRP-metal composite components and corresponding production methods therefor are known, for example, from WO 2014/111376 A1, DE 10 2012 001 577 A1, EP 2 033 849 A1, CN 104197790 A, EP 2 650 108 A1 and U.S. Pat. No. 4,545,105. These essentially have the common feature that a metal main body is reinforced with a fiber-reinforced plastic or a fiber-reinforced plastic is reinforced with metal inserts. The fiber-reinforced plastic can be hardened in this case by the supply of heat, with the plastic having been joined together with the metal body beforehand, such that a form-fitting and integral unit composed of metal body and fiber-reinforced plastic is formed after the hardening of the plastic.

In order to furthermore provide the metal body with a high strength, for example in the case of hardenable aluminum alloys, it is generally known to subject said metal body to a heat treatment, for example age hardening or bake hardening.

### SUMMARY

The present disclosure provides a method for producing a structural component for a motor vehicle, in particular a motor vehicle body component such as for example supports or pillars. In this respect, the method reduces the steps for producing the structural component and yields a high-strength structural component of low weight.

It is pointed out that the features specified individually in the following description may be combined with one another in any desired technically meaningful way and provide further variations of the present disclosure.

According to the present disclosure, a method for producing a structural component for a motor vehicle, in particular a motor vehicle body component such as for example supports or pillars, which has a main body made of a metal material, for example aluminum, steel, magnesium, an alloy comprising the aforementioned metal materials, and the like, which is provided at least partially with at least one reinforcing element made of a fiber-composite plastic or a fiber-reinforced plastic (FRP), comprises at least the following steps:
providing the main body;
providing the reinforcing element;
joining the main body and the reinforcing element together; and
simultaneously heating the main body and the reinforcing element to a temperature and for a period of time which are chosen to be sufficiently high in order to harden both the metal material of the main body and also the fiber-composite plastic of the reinforcing element.

In this way, the step of simultaneous heating advantageously involves two method steps being combined and performed at the same time, namely the hardening of the metallic main body and the hardening of the fiber-composite plastic. This simultaneously increases both the strength of the metallic main body and also the strength of the fiber-composite plastic, which additionally forms a form-fitting and/or integral unit with the main body after the hardening. The method according to the present disclosure consequently makes it possible to produce a high-strength structural component of low weight with few method steps, as a result of which the production costs and the production duration for the structural component can be reduced. On account of the reinforcement of the main body which is brought about by the reinforcing element, the metallic main body can have a comparatively small and therefore weight-reducing wall thickness.

According to the present disclosure, the hardening of the metallic main body is to be understood in particular as age hardening or bake hardening. Both methods achieve an increase in the strength of the metal material by heating it. Age hardening is based on the precipitation of metastable phases in finely distributed form, such that the latter constitute an effective obstacle to dislocation motions and therefore increase the strength of the metal material considerably. During bake hardening, the strength of the metal material is increased by the accumulation of carbon atoms at dislocations. By way of example, the bake hardening can also be effected at the same time as the firing of a lacquer in the metal material, to the extent that this is to be provided. The metal material in one form is heated to a temperature of approximately 200° C. for hardening.

Fibers of glass, carbon, aramid and the like are in one form embedded in the fiber-composite plastic. Or in other words, the fibers are embedded in a matrix (plastic/resin) to create a fiber-reinforced composite.

According to one variation of the present disclosure, the step of providing the main body comprises the shaping of the main body into a desired shape. Therefore, the metallic main body can already be preshaped before it is joined together with the reinforcing element.

Another variation of the present disclosure provides that the step of providing the reinforcing element comprises the preimpregnation of reinforcing fibers with a thermosetting polymer matrix. The matrix surrounds the fibers, for example glass fibers, carbon fibers, aramid fibers and the like, which are bound to the matrix by adhesive or cohesive forces. It is thereby possible to achieve a reinforcing element of low weight having high specific rigidities and strengths, it being possible for these properties to be transferred by the assembly with the metallic main body to the structural component to be produced.

According to yet another variation of the present disclosure, the step of joining together comprises the pressing of the main body and the reinforcing element together, such that, after the pressing together, at least certain portions of the reinforcing element have a shaping which corresponds to the main body, as a result of which the strength properties of the structural component can be improved yet further.

In order to inhibit the relative displacement between the main body and the reinforcing element after they have been joined together, another variation of the present disclosure provides that the step of joining together comprises the at least local and temporary fastening of the reinforcing element on the main body. By way of example, the fastening can be effected in an integral manner, in that for example, before the main body and the reinforcing element are joined together, an adhesive is applied to the main body and/or the reinforcing element in order to form an integral bond between the main body and the reinforcing element after they have been joined together. In addition or as an alternative, the reinforcing element can also be fastened on the main body by means of at least one form-fitting and/or force-fitting element. By way of example, this can be provided on the reinforcing element itself, for example in the form of a clip, hook and the like, and/or else on the main body, in order to form a form fit and/or force fit between the main body and the reinforcing element after the latter have been joined together. In any case, a relative displacement is thereby inhibited. The form-fitting and/or force-fitting elements can be removed after the joint heat treatment.

After the heat treatment, the main body is connected to the reinforcing element, and therefore a separate connection process is avoided.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is includes plurality of perspective views of a process for joining a main body made of a metal material together with a reinforcing element made of a fiber-composite plastic, in order to obtain a first exemplary form of a structural component according to the present disclosure; and

FIG. 2 is a perspective view of a second form of a structural component according to the present disclosure with form-fitting and/or force-fitting elements constructed according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the different figures, parts of equivalent function are always provided with the same reference signs, and so said parts are generally also described only once.

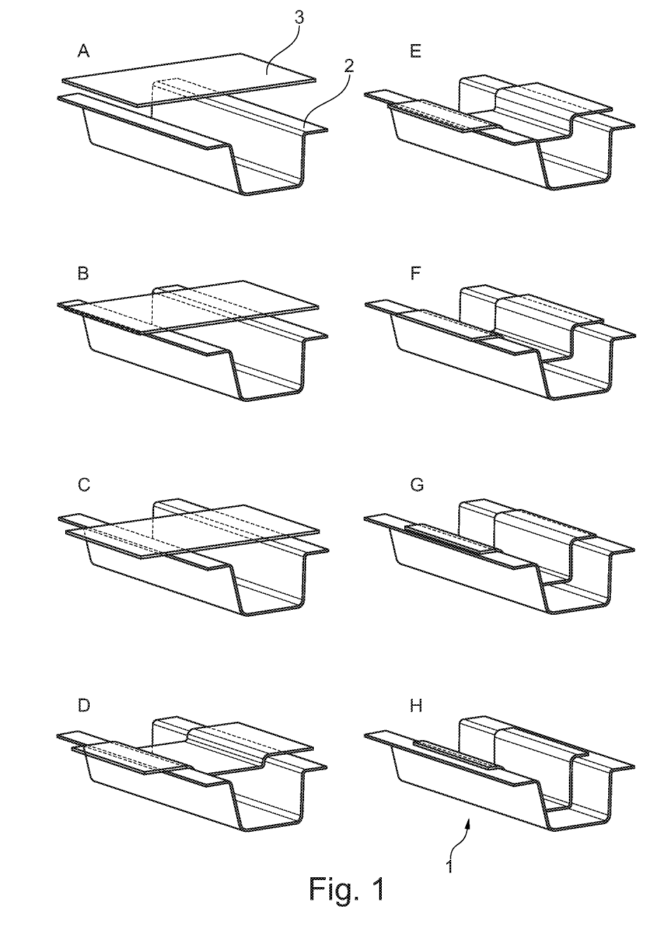

FIG. 1 shows a perspective view of a first exemplary form of a structural component 1 according to the present disclosure. In particular, FIG. 1 shows a sequence of a plurality of perspective views A to H of a process for joining a main body 2 made of a metal material together with a reinforcing element 3 made of a fiber-composite plastic (FRP), in order to obtain the structural component 1 according to the present disclosure.

In view A in FIG. 1, the preshaped metallic main body 2 and the unshaped reinforcing element 3, which has a multiplicity of fibers embedded in a thermosetting polymer matrix, are each provided. In the subsequent views B to H, the main body 2 and the reinforcing element 3 are joined together or pressed together in such a manner that, after the pressing together, the reinforcing element 3 has a shaping which corresponds to the main body 2, as is shown in view H.

After the joining together, the structural component 1 shown in view H is heated such that the main body 2 and the reinforcing element 3 are simultaneously heated to a temperature and for a period of time which are chosen to be sufficiently high in order to harden both the metal material of the main body 2 and also the fiber-composite plastic of the reinforcing element 3. By way of example, the heat treatment of the structural component 1, for example in an autoclave or a furnace, can encompass a temperature of approximately 200° C. After the reinforcing element 3 has been hardened, it is connected to the main body 2. Ideally, a form-fitting and/or integral bond is formed. In this case, the matrix or the resin serves as it were as an adhesive between the main body 2 and the reinforcing element 3.

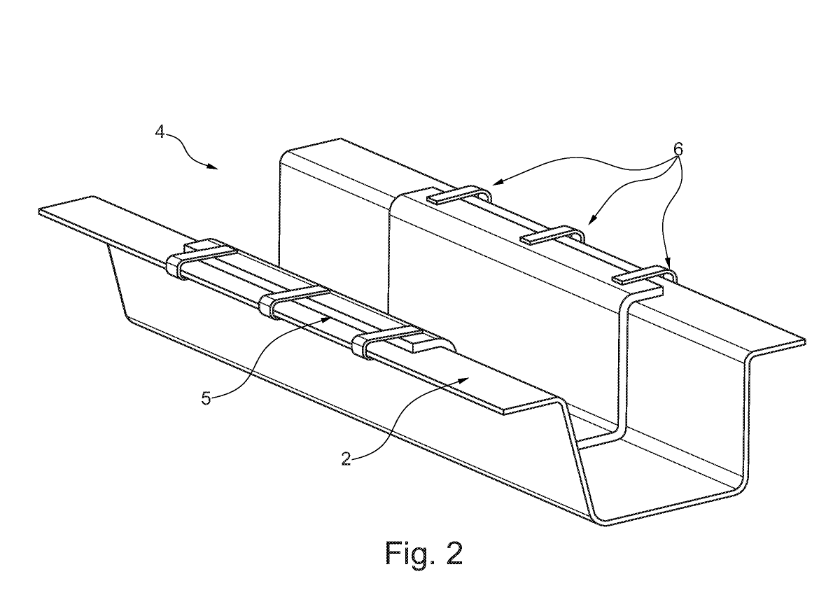

FIG. 2 shows a perspective view of a second exemplary form of a structural component 4 according to the present disclosure. In the case of the structural component 4 which is shown, a reinforcing element 5, after it has been joined together with the metallic main body 2, has been temporarily connected in a form-fitting and/or force-fitting manner to the main body 2, i.e. fastened thereon in a positionally secure manner, with the aid of a plurality of form-fitting and/or force-fitting elements 6, shown here in the form of clip-like elements 6, in order to inhibit the reinforcing element 5 and the main body 2 from being able to be displaced in relation to one another after they have been joined together and before the simultaneous heating. After the reinforcing element 5 has been hardened, it is connected to the main body 2 in a form-fitting and/or integral manner.

As an alternative or in addition to the form-fitting and/or force-fitting elements 6, the reinforcing element 5 can also be fastened on the main body 2 in a positionally secure manner with the aid of an adhesive during the joining together. To this end, before the main body 2 and the reinforcing element 5 are joined together, an adhesive may be applied to the latter. The main body 2 and the reinforcing element 5 are also already integrally connected to one another by the adhesive before the joint hardening.

The above-described method according to the present disclosure is not restricted to the variations disclosed herein, but rather also encompasses other variations which have an identical effect.

In one form, the structural component 1 produced by the method according to the present disclosure is used as a body component, for example as a motor vehicle B pillar, in a motor vehicle.

The description of the disclosure is merely exemplary in nature and, thus, variations that do not depart from the substance of the disclosure are intended to be within the scope of the disclosure. For example, thermoplastic resins/plastics may be employed (at higher bonding temperatures), which would be compatible with temperatures of the metallic main body. Further a plurality of main bodies and reinforcing elements may be employed in a variety of applications, which are not limited to a motor vehicle, while remaining within the scope of the present disclosure. Such variations are not to be regarded as a departure from the spirit and scope of the disclosure.

What is claimed is:

1. A method for producing a structural component for a motor vehicle, in particular a motor vehicle body component, which has a main body made of a metal material which is provided at least partially with at least one reinforcing element made of a fiber-composite plastic, said method comprising:
providing the main body;
providing the reinforcing element;
joining the main body and the reinforcing element together; and
simultaneously heating the main body and the reinforcing element to a temperature and for a period of time which are chosen to be sufficiently high in order to harden both the metal material of the main body and also the fiber-composite plastic of the reinforcing element.

2. The method according to claim 1, wherein the step of providing the main body comprises shaping the main body into a desired shape.

3. The method according to claim 1, wherein the step of providing the reinforcing element comprises preimpregnation of reinforcing fibers with a thermosetting polymer matrix.

4. The method according to claim 1, wherein the step of joining together comprises pressing of the main body and the reinforcing element together, such that, after the pressing together, at least certain portions of the reinforcing element have a shaping which corresponds to the main body.

5. The method according to claim 1, wherein the step of joining together comprises the at least temporary, positionally securing the reinforcing element on the main body.

6. The method according to claim 5, wherein before the main body and the reinforcing element are joined together, an adhesive is applied to the reinforcing element in order to form an integral bond between the main body and the reinforcing element after the main body and the reinforcing element have been joined together and before the main body and the reinforcing element are hardened together.

7. The method according to claim 5, wherein the positionally securing is accomplished by at least one a form-fitting and a force-fitting element.

8. The method according to claim 7, wherein the at least one a form-fitting and a force-fitting element define a shape of a clip.

9. The method according to claim 5, wherein the positionally securing is accomplished by at least one a form-fitting and a force-fitting element and an adhesive.

10. The method according to claim 1, wherein the main body is aluminum, and the reinforcing element is a fiber-reinforced thermosetting composite.

11. A part manufactured according to the method of claim 1.

12. A motor vehicle having at least one part manufactured according to the method of claim 1.

13. A method for producing a structural component for a motor vehicle, in particular a motor vehicle body component, which has a main body made of a metal material which is provided at least partially with at least one reinforcing element made of a fiber-composite plastic, said method comprising:
providing the main body;
providing the reinforcing element;
joining the main body and the reinforcing element together and positionally securing the reinforcing element on the main body by at least one a form-fitting and a force-fitting element; and
simultaneously heating the main body and the reinforcing element to a temperature and for a period of time which are chosen to be sufficiently high in order to harden both the metal material of the main body and also the fiber-composite plastic of the reinforcing element.

14. The method according to claim 13, wherein the step of providing the reinforcing element comprises preimpregnation of reinforcing fibers with a thermosetting polymer matrix.

15. The method according to claim 13, wherein the step of joining together comprises pressing of the main body and the reinforcing element together, such that, after the pressing together, at least certain portions of the reinforcing element have a shaping which corresponds to the main body.

16. The method according to claim 13, wherein before the main body and the reinforcing element are joined together, an adhesive is applied to the reinforcing element in order to form an integral bond between the main body and the reinforcing element after the main body and the reinforcing element have been joined together and before the main body and the reinforcing element are hardened together.

17. The method according to claim 13, wherein the main body is aluminum, and the reinforcing element is a fiber-reinforced thermosetting composite.

18. The method according to claim 13, wherein the at least one a form-fitting and a force-fitting element define a shape of a clip.

19. A part manufactured according to the method of claim 13.

20. A motor vehicle having at least one part manufactured according to the method of claim 13.
